(19) United States
(12) Patent Application Publication
(10) Pub. No.: US 2020/0391676 A1
(43) Pub. Date: Dec. 17, 2020

(54) Vehicle Protection Device

(71) Applicants: Bill M. Wu, Elk Grove, CA (US); Sam A. Wu, Elk Grove, CA (US)

(72) Inventors: Bill M. Wu, Elk Grove, CA (US); Sam A. Wu, Elk Grove, CA (US)

(21) Appl. No.: 16/439,459

(22) Filed: Jun. 12, 2019

(51) Int. Cl. B60R 13/04

(52) U.S. Cl. CPC B60R 13/04

(57) ABSTRACT

The disclosed invention relates to a removable protective device that attaches to the side of a vehicle in order to protect the vehicle from minor damage that often occurs from the inadvertent opening of adjacent vehicle doors. More specifically, the present invention is a padded protector strip having tapered ends with a gradual chamfer, wherein one end is inserted into the gap of the front driver or passenger side door hinge. The protector strip attaches magnetically to the vehicle door, while the insertion of one of the tapered ends into the gap of the door hinge prevents undesired removal from the vehicle when the door is closed. The removable protective device provides protection from incidental damage to the vehicle doors, and can be rolled up and secured in a coil configuration for easy and convenient storage.

### BACKGROUND OF THE INVENTION

### I. Field of the Invention

The disclosed invention relates to a removable protective device that attaches to the side of a vehicle in order to protect the vehicle from minor damage that often occurs from the inadvertent opening of adjacent vehicle doors. More specifically, the present invention is a padded protector strip having tapered ends with a gradual chamfer, wherein one end is secured to the vehicle door by insertion into the gap of the front driver or passenger side door hinge. The protector strip attaches magnetically to the vehicle door, while the insertion of one of the tapered ends into the door hinge prevents undesired removal from the vehicle when the door is closed. The removable protective device provides protection from incidental damage to the vehicle doors, and can be rolled up and secured in a coil configuration for easy and convenient storage.

### II. Background Art

Most all minor damage to vehicles occurs to the side body panels, specifically the vehicle doors, when parked in public places. Dents and scratches are commonplace occurrences from adjacent parked vehicles. In an attempt to address this pervasive problem, vehicle manufacturers began offering and/or including permanently affixed side door protectors on various vehicle models. However, the permanent affixed door protectors provide insufficiently limited protection. The depth and height of the protective strips, made of plastic, rubber, or metal, offer minimal protection from adjacent vehicles having high and low points on door edges that miss the center of the affixed protective strips. Further, the appearance of these permanent protective strips detract from the overall appearance of the vehicle and, as such, consumers often opt for models without protective strips.

There are presently several types of removable vehicle door protector devices offered commercially, each with their own set of drawbacks. U.S. Pat. No. 5,072,979 presents a foam protective device with magnets and theft security, but specifies that the device consists of 2-3 parts, with tabs that hook into the door jambs. This design suggests difficulty with manipulation of parts and bulky storage. Additionally, because the hooks are in direct contact with the vehicle, damage to the paint at the points of contact is inevitable over time. U.S. Pat. No. 9,771,032, and US 2017/0113530 are formed by two separate foam panels with a magnetic strip for adhesions, and cords running through the panels. The cords have rings that are mechanically attached and can be closed in the door to prevent theft. Again, there is a problem with the bulkiness and the rigidity of the pads. Adhering the magnetic strip to the pads with glue causes undesirable stiffness and prevents any type of folding or coiling for storage. Further, any gap in between the separate padding leaves room for potential damage to the vehicle due to the open gap leaving the gapped part of the vehicle vulnerable to potential contact. U.S. Pat. No. 5,320,392 presents similar drawbacks as it is semi-rigid with magnetic strips and a cable running through the pads. An alternative embodiment is presented with suction cups. However, the suction cups, as well as the magnetic strips, cause damage to the paint of the vehicle over time. Whether this is due to hot weather or other mechanical factors, consumers have pointed to this problem with removable protective devices that have adhesive elements in direct contact with the vehicle. U.S. Pat. No. 9,771,032 also presents a similar problem with the attachable device, specifically using a magnetic strip. This invention also offers no protection from theft. U.S. Pat. No. 8,444,191 protects against theft by using spring-loaded clips that attach to a cable that is connected to the protective padding. The clips cannot be removed unless the door is open. However, despite designing for minimal rough edges, the contact of the clips and cable rubbing on the edge of the door over time would eventually cause damage to the paint. Additionally, the clips and cables cause difficulty with handling. U.S. Pat. No. 8,162,383 presents a self-coiling, one piece pad, but fails to provide for any protection from theft.

The embodiments of the prior art, while providing for some degree of protection from dents and dings, are nonetheless problematic due to the rigidity and also bulkiness, creating operational difficulties with handling and also difficulty with manipulation for storage. Additionally, despite any coupling of separate bumper pieces, the center is left open with a gap between pieces, thereby leaving the car susceptible to damage at the center of the doors. The coupling members also cause damage to the vehicle paint with long term usage due to abrasion at the contact point. Damage to vehicle paint has also been noted by consumers using protective devices that have magnetic strips in direct contact with the vehicles. Further, those embodiments that offer theft protection consist of elements that cause damage over time to the vehicles at the point of attachment or contact with the vehicle, and are also more challenging to handle and manipulate. The present invention addresses these shortcomings of the prior art vehicle door protectors.

### SUMMARY OF THE INVENTION

The present invention is a removable protective device for side body panels of vehicles in the form of a solid, elongated belt-like structure made of semi-rigid padded foam that magnetically attaches to the side of a vehicle, long enough to extend across the front and rear side doors/panels. The structure has a thickness sufficient to shield off unwanted contact from doors of adjacent parked vehicles with varying high and low door edge contact points. Magnets are embedded into the foam padding, so as to avoid direct contact with the vehicle. The elongated device protector has tapered ends with a gradual chamfer, with one end inserted into the gap of the front driver or front passenger door hinge, providing a unique security feature that prevents unintentional and undesired removal when the device protector is clamped into place by closure of the door. Storage of the device protector is facilitated by rolling the strip into a compact coil or alternatively into two smaller coils.

### BREIF DESCRIPTION OF THE DRAWINGS

The present invention is further described by the illustrative drawings set forth below. The drawings are purely for illustrative purposes and not intended to capture all embodiments of the invention.

FIG. 1 is a schematic view of the protector device magnetically attached to the vehicle side body panel with one end clamped into the hinge gap of the front driver door.

FIG. 2 is an angled view of the protector device rolled up with a fastener in a storage position.

FIG. 3 is a perspective view of the protector device showing cutaway details.

FIG. 4 is a side profile view of the protector device fully extended and showing placement of the hidden magnets.

### DETAILED DESCRIPTION OF THE PREFERRED EMBODIMENTS

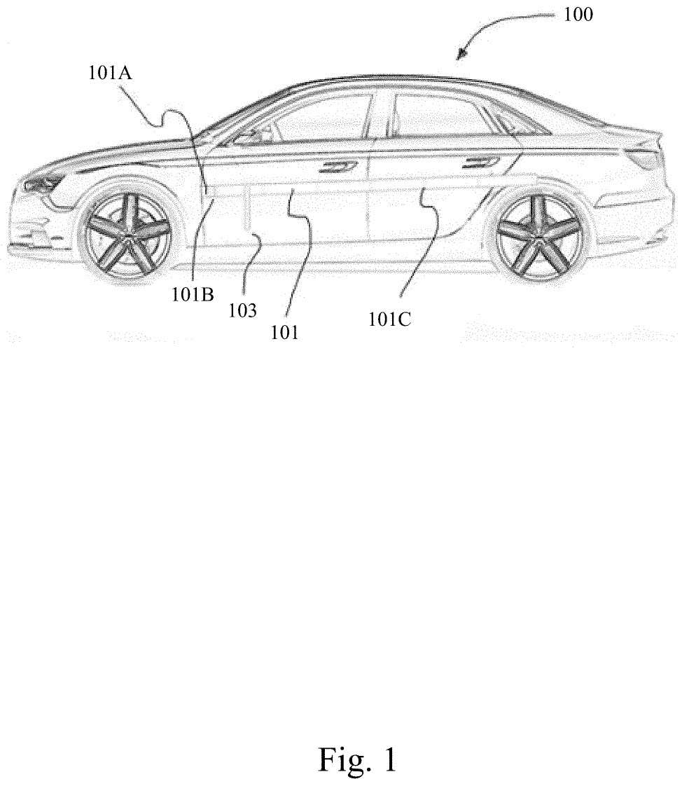

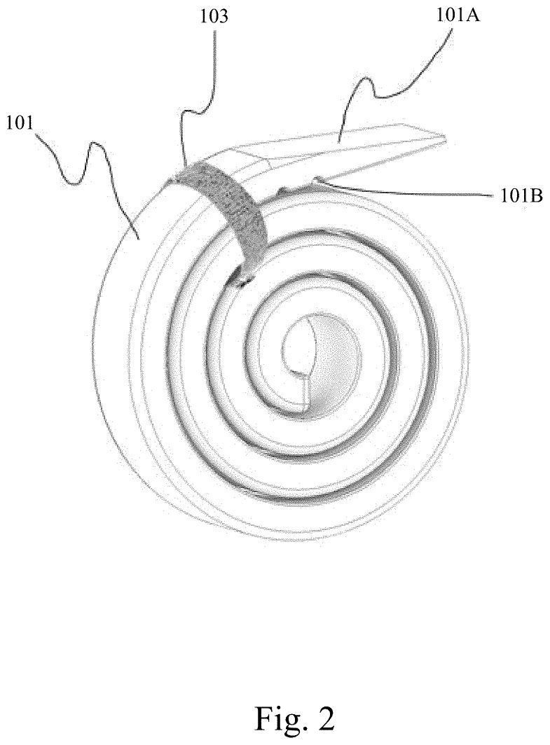

The present invention comprises a vehicle side body panel protector device. Referring to FIG. 1, the vehicle 100 is illustrated as equipped with the elongated protector device 101, having a tapered ends 101A with a gradual chamfer on the outer side of the strip. To prevent undesired removal or theft, merely insert one of the ends into the gap of the front driver or passenger door hinge and close the door to secure the end. Contouring creasing notches 101B are added to the inner side of the strip at the tapered ends to facilitate a bend in material when clamped into place, also shown in FIG. 2. Magnets 101C are embedded throughout the length of the strip to adhere the device to the vehicle 100. A storage strap 103 is used to secure the device into a coiled position for easy and convenient storage, illustrated in FIG. 2.

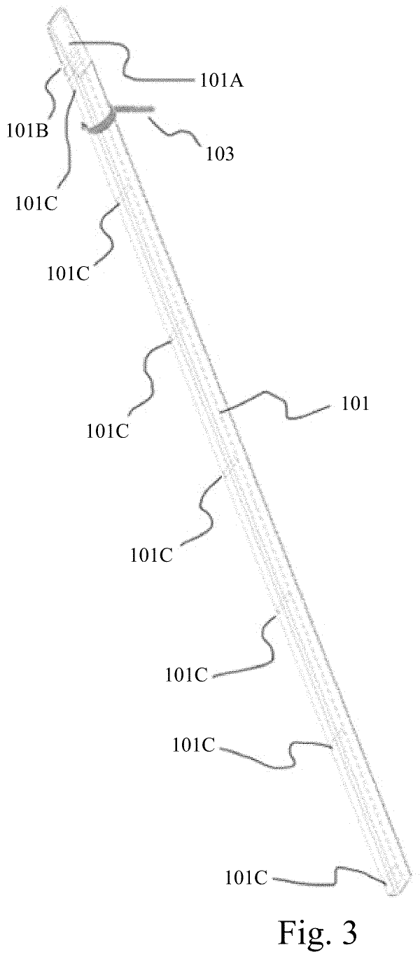

FIG. 3 shows the magnets 101C embedded into slotted cavities spaced equidistant from each other throughout the length of the protective strip 101. The magnets are bonded within the padding strip by an adhesive, sealing the openings of the slotted cavities and securing the magnets in place. Embedding the magnets into the protective strip prevents direct contact with the vehicle and, therefore, prevents damage to the paint, which occurs when adhesive elements, such as magnetic strips, are used over time. The adhesive used to bond the magnets is spaced equidistant over the length of the strip, as opposed to using the adhesive over the entire length. This prevents rigidity and allows for easier handling and manipulation, as the protective strip remains a flexible.

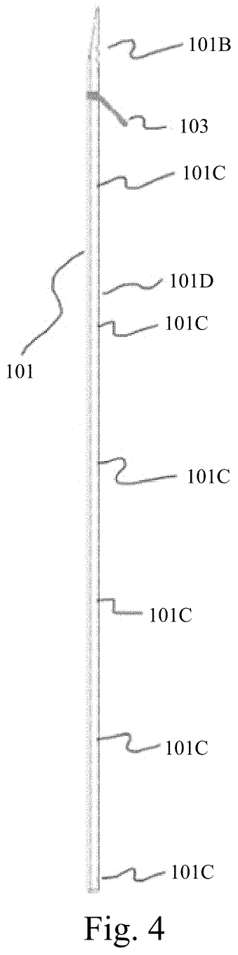

FIG. 4 illustrates a cutaway view of the device 101 having multiple cavities with magnets 101C embedded. The clamping of the tapered end 101A into the door gap forms an arc or kink which is reduced by the notches 101B on the inner side of the strip to facilitate the bend at the end when clamped into place by closing the door. It is imperative that no magnets are exposed outside of the foam padding to prevent any direct contact with the body of the vehicle. FIG. 4 shows the side profile view displaying the plurality of pocket cavities of the elongated belt protector 101 having a thin separation layer where the magnets 101C are embedded into and away from the rear side surface of the elongated protector device rear facing surface 101D.

The protective device 101 is constructed of high tensile weather-resistant foam. The main body structure can be either extruded or mold-injected, yielding different manufactured aesthetics. Injection molding gives the outer surface of the device more aerodynamic edges and does not restrict embossing custom markings directly onto the device. Alternatively, extrusion imposes limitations to various corners of the body surfaces of the device, limiting aesthetic features of the protector, but does not affect the protective shielding of the device.

The preferred embodiment is formed with high tensile, closed cell foam, wherein the foam is resistant to liquid absorption and the high tensile strength provides for strength to resist tearing. Polychloroprene is the preferred material to be used for the body structure of the present protector device given that it provides high tensile strength, flexibility, and weather resistance. Other choices of closed cell foam material may be used as an acceptable alternative, such as Ethelyne Vinyl Acetate (EVA), but polychloroprene is currently more advantageous for its flexibility, less rigidity, and ease of handling by the user when the protective device is in the coiled storage position.

Dimensions of the preferred embodiment are three inches in width, 80 inches overall in length, and with a depth thickness of more than 0.5 inches. The user may reduce the overall length by cutting the strip to the desired length. The shape of the protective strip 101 and the continuous form of this one-piece device makes this device easier to handle and manipulate, and less bulky than the prior art forms. Additionally, as this device is one continuous piece, there is no gap opening where the vehicle would be exposed to potential damage, nor would there be any damage from couple members used to connect separate pieces.

Earth magnets 101C, typically known as neodymium, are also preferred for their strength, which is advantageous when using cellular foam. The scope of the present invention is furthered envisioned to include flexible materials, such as plastic, silicone, and any other resilient materials.

There are several material options that may be used for the storage strap 103, which is attached to the protective strip 101 and used to secure the strip into a coiled configuration. However, the preferred embodiment consists of a Velcro strap to quickly and easily secure the coil. Other suitable materials include plastic ties, silicone ties, fabric based ties, and snaps. An additional strap may be included at the opposite end so that both ends may be coiled and secured separately.

In addition to the protective qualities this device provides, the user will appreciate the simplicity of the present invention and the ease of utility created by the single form of the continuous strip, with no cables, hooks, clamps, or clips. Applying the protective device to the side panel of vehicle and securing the strip takes no more than a few seconds. The ratio of the narrow vertical width to the side panels on the car door is aesthetically pleasing, unlike the prior art devices, which are also bulky and less protective. Furthermore, securing the protective strip from unwanted removal or theft consists of simply inserting one of the ends into the gap of the door and closing the door.

1. An apparatus for protecting a vehicle door comprising:
An elongated strip with an inner side and an outer side,
wherein the inner side is positioned flat against a side of a vehicle and the outer side is exposed as a protective barrier,
wherein at least one end of the strip is tapered with a gradual chamfer at the end of the outer side of the elongated strip;
A plurality of cavities positioned along the length of the elongated strip,
wherein the cavities are positioned in the middle of the elongated strip in between the inner side and the outer side;
A plurality of magnets, wherein each magnet is embedded within a single cavity of the plurality of cavities; and
At least one notch, wherein said at least one notch is positioned on the inner side, opposite of the chamfer.

2. An apparatus according to claim 1, further comprising:
At least one connective member attached to the elongated strip.

3. An apparatus according to claim 2, wherein the magnets are made of neodymium.

4. An apparatus according to claim 3, wherein the elongated strip is made of a high tensile, closed cell foam.

5. An apparatus according to claim 4, wherein said at least one connective member consists of a Velcro tie.

6. An apparatus for protecting a vehicle door comprising:
An elongated strip with an inner side and an outer side, wherein the inner side is positioned flat against a side of a vehicle and the outer side is exposed as a protective barrier,
wherein one end of the elongated strip has a tongue-like extension protruding from the end of the elongated strip;
A plurality of cavities positioned along the length of the elongated strip, wherein the cavities are positioned in the middle of the elongated strip in between the inner side and the outer side;
A plurality of magnets, wherein each magnet is embedded within a single cavity of the plurality of cavities; and
At least one notch, wherein said at least one notch is positioned on the inner side of the elongated strip.

7. An apparatus according to claim 6, further comprising:
At least one connective member attached to the elongated strip.

8. An apparatus according to claim 7, wherein the magnets are made of neodymium.

9. An apparatus according to claim 8, wherein the elongated strip is made of a high tensile, closed cell foam.

10. An apparatus according to claim 9, wherein the elongated strip and the tongue-like extension are one solid, continuous strip.

11. An apparatus according to claim 10, wherein said at least one connective member consists of a Velcro tie.

12. A method for protecting a vehicle door from dings and dents, the method comprising
Placing an apparatus against a vehicle door, wherein the apparatus includes:
An elongated strip with an inner side and an outer side, wherein the inner side is positioned flat against a side of a vehicle and the outer side is exposed as a protective barrier, wherein at least one end of the elongated strip is tapered with a gradual chamfer at the end of the outer side of the elongated strip;
A plurality of cavities positioned along the length of the elongated strip, wherein the cavities are positioned in the middle of the elongated strip in between the inner side and the outer side;
A plurality of magnets, wherein each magnet is embedded within a single cavity of the plurality of cavities, and wherein the apparatus magnetically adheres to the vehicle door;
At least one notch, wherein said at least one notch is positioned on the inner side, opposite of the chamfer to facilitate storage of the apparatus in a rolled up, coiled configuration; and
Wherein one end of the elongated strip is closed within the gap of the vehicle door to secure the apparatus in place.

13. A method according to claim 12, further comprising:
At least one connective member attached to the elongated strip to facilitate storage when the apparatus is removed from the vehicle, wherein the connective member secures the apparatus into a rolled up, coil configuration.

14. A method according to claim 13, wherein the magnets are made of neodymium.

15. A method according to claim 14, wherein the elongated strip is made of a high tensile, closed cell foam.

16. A method according to claim 15, wherein said at least one connective member consists of a Velcro tie.

17. A method for protecting a vehicle door from dings and dents, the method comprising
Placing an apparatus against a vehicle door, wherein the apparatus includes:
An elongated strip with an inner side and an outer side, wherein the inner side is positioned flat against a side of a vehicle and the outer side is exposed as a protective barrier,
wherein one end the elongated strip has a tongue-like extension protruding from the end of the elongated strip;
A plurality of cavities positioned along the length of the elongated strip, wherein the cavities are positioned in the middle of the elongated strip in between the inner side and the outer side;
A plurality of magnets, wherein each magnet is embedded within a single cavity of the plurality of cavities; and
At least one notch, wherein said at least one notch is positioned on the inner side of the elongated strip to facilitate storage of the apparatus in a rolled up, coil configuration; and
Wherein one end of the elongated strip is closed within the gap of the vehicle door to secure the apparatus in place.

18. A method according to claim 17, further comprising:
At least one connective member attached to the elongated strip to facilitate storage when the apparatus is removed from the vehicle, wherein the connective member secures the apparatus into a rolled up, coil configuration.

19. A method according to claim 18, wherein the magnets are made of neodymium.

20. A method according to claim 19, wherein the elongated strip is made of a high tensile, closed cell foam.
